(19) United States
(12) Patent Application Publication
(10) Pub. No.: US 2016/0232187 A1
(43) Pub. Date: Aug. 11, 2016

(54) DUMP ANALYSIS METHOD, APPARATUS AND NON-TRANSITORY COMPUTER READABLE STORAGE MEDIUM

(71) Applicant: HITACHI, LTD., Tokyo (JP)

(72) Inventor: Yuichiro AOKI, Tokyo (JP)

(21) Appl. No.: 15/021,801

(22) PCT Filed: Feb. 3, 2014
(86) PCT No.: PCT/JP2014/052394

§ 371 Date: Mar. 14, 2016

(51) Int. Cl. G06F 17/30; G06F 11/07

(52) U.S. Cl. CPC G06F 17/30321; G06F 17/30988; G06F 17/30958; G06F 11/079; G06F 11/0727

(57) ABSTRACT

Data to be subjected to a binary search is arranged in ascending order of data[1]<data[2]< . . . <data[N], and when the range of data[1] to data[N] is searched, data in the vicinity of data[N], where the target data is not present, is searched, resulting in wasted search time. There has been the problem that a binary search used in analysis of a HPROF dump file results in the long search time. When objects included in an HPROF dump are plotted on a graph having the object identifier as the first axis and the row number as the second axis, the information of an area smaller than a rectangle indicated by the graph origin and the position of the greatest object identifier is selected as index information for object identifiers for that can be referenced, and the binary search on the object identifiers is performed by using the selected index information.

### BACKGROUND

The present invention relates to an analysis method and apparatus of a dump file outputted by a computer program.

If a memory fault such as a memory leak is suspected to have occurred in a computer program (hereinafter, abbreviated as a program) running on a computer system, it is common to obtain a memory dump of the memory used by the program and examine the memory dump to locate the cause. Recent computer systems, particularly servers and personal computers, often have large capacity memory. For example, a server or a personal computer with a memory of more than 1 gigabyte (GB) is no longer uncommon. Large capacity memory in a computer system results in a memory dump of large size in the computer system. In general, the size of a memory dump is comparable to the memory size; thus it is not uncommon for the size of a recent memory dump to exceed 1 GB. A large memory dump leads to a long time to analyze the memory dump, resulting in a long time to locate the cause of a memory failure. The shorter the time to analyze the memory dump becomes, the shorter the service outage time becomes. Therefore, in these days, it has been strongly desired to shorten the time required for analysis of the memory dump even in a computer system with large capacity memory. In the following, a HPROF dump file is described as an example of a memory dump. A HPROF dump file is outputted by a Java virtual machine that runs programs written in the Java language, which is widely used in enterprise computer systems that support the foundation of a society, such as online financial processing. Note that the present invention may be applied to a memory dump created by a program written in a general programming language in addition to the Java virtual machine and the HPROF dump file (Java and all trademarks and logos related with Java are registered trademarks or trademarks in the United States and other countries for Oracle Corporation and its subsidiaries.).

The Java virtual machine is a type of virtual machine the runs programs described in the Java language. The Java virtual machine running on a computer system with large capacity memory is often provided with Java heap memory of a large size as a work area in memory. The Java heap memory is a memory area for storing objects of Java in the process of the Java virtual machine. Therefore, the size of a HPROF dump file, which is an example of a dump file of the Java heap memory generated by the Java virtual machine, increases.

Non-Patent Literature 1: Donald E. Knuth. 2006. “The Art of Computer Programming Volume 3 Sorting and Searching Second Edition Japanese Version”. Translation supervised by Makoto Arisawa and Eiichi Wada. Translated by Yuichiro Ishii, Hiroshi Ichiji, Hiroshi Koide, Kumiko Tanaka and Takahiro Nagao. ASCII Corporation.

### SUMMARY

When pieces of data are arranged in ascending order, if a given VALUE is closer to data[1] than data[N], it is apparent that there is no VALUE in the vicinity of data[N]. However, in the prior art, the initial value of the search range lower limit LOW of the binary search is always 1 (LOW=1) and the search range upper limit HIGH of the binary search is always N (HIGH=N), resulting in a search performed near data[N]. The search near data[N] is a vain search and thus causes a problem that the time required for the binary search, more specifically, the time required for analysis of an HPROF dump file increases.

In order to solve the above problem, for example, the configuration described in the claims is employed. The present invention includes a plurality of means for solving the problem, and an example includes collecting, by a reading unit, index information from dump information stored in a first storage area and storing the index information in the first storage area, the index information consisting of object identifiers arranged in ascending or descending order and row numbers each being information regarding an offset in a file of corresponding object identifier of the object identifiers; selecting, by a selection unit, information of an region on a graph with a first axis indicating the object identifiers and a second axis indicating row numbers as index information that can be referenced, the area being smaller than a rectangle defined by an origin point and a position of a maximum object identifier on the graph when points of the object identifiers are plotted on the graph; and performing, by a analysis unit, a binary search on the object identifiers by using the selected index information.

An aspect of the present invention can shorten the time of a dump analysis to perform a binary search.

### BRIEF DESCRIPTION OF THE DRAWINGS

FIG. 1 is an example of a diagram illustrating initial values of binary search range upper limit HIGH and lower limit LOW calculated according to an embodiment of the present invention on a graph;

FIG. 2 is an example of a diagram illustrating initial values of the binary search range upper limit HIGH and lower limit LOW calculated according to an embodiment of the present invention in tabular form;

FIG. 3 is an example of a diagram of a computer system according to an embodiment of the present invention;

FIG. 4 is an example of a diagram of a HPROF dump file;

FIG. 5 is an example of a diagram of an index information file;

FIG. 6 is an example of a flowchart showing processing according to an embodiment of the present invention;

FIG. 7 is an example of a flowchart showing object search range calculation processing according to an embodiment of the present invention;

FIG. 8 is an example of a diagram illustrating a binary search range calculated according to an embodiment of the present invention on a graph;

FIG. 9 is another example of a flowchart showing object search range calculation processing according to an embodiment of the present invention; and

FIG. 10 is another example of a diagram illustrating a binary search range calculated according to an embodiment of the present invention on a graph.

### EMBODIMENTS

In the following, embodiments for practicing the present invention will be described in detail with reference to the accompanying drawings.

An HPROF dump file is created by outputting information regarding objects in the Java heap memory of the Java virtual machine while tracing the objects in the Java heap memory from the lower side (smaller memory address side) toward the higher side (larger memory address side) in the Java heap memory. In addition, the information regarding each object includes a serial number which is selected from a series with irregular intervals and referred to as object identifier (corresponding to a memory address of each object on the Java heap memory of the Java virtual machine) at the beginning of the information. Each value of the object identifier is unique. The pieces of information on the objects are arranged in ascending order of the object identifier from the head towards the end of the HPROF dump file. The ascending order means that the magnitude relationship of data[1]<data[2] . . . <data[N] is established in data[1] to data[N]. Conversely, if the magnitude relationship of data[1]>data[2]> . . . >data[N] is established, it is referred to as descending order. “An identifier of an object” in the claims is the same as an object identifier.

The created HPROF dump file is analyzed in the following manner.

First, an analysis apparatus scans the HPROF dump file from the head toward the end of the HPROF dump file, obtains the object identifier assigned to each object and the offset indicating the number of bytes from the head to the location of each object in the HPROF dump file, and stores each pair of the two values in a temporary file (hereinafter, referred to as index information file). The index information file contains the object identifier and the offset of an object in the same row. The rows are labeled with row numbers. The processing consisting of these processing steps is referred to as read processing and a unit that performs the read processing is referred to as reading unit.

Next, the analysis apparatus receives an object identifier inputted from a HPROF dump file analyst (hereinafter, referred to as user), a configuration file or the like, and obtains the information about the object identified by the object identifier from the HPROF dump file using the offset stored in the index information file. The analysis apparatus analyzes the obtained information about the object in various ways and outputs information necessary to identify the cause of a memory error, such as the object size and the reference relationships between objects. An object may have the object identifier of another object which the object refers to (hereinafter, referred to as referee object identifier). If a referee object identifier is obtained by the analysis, the analysis apparatus performs the processing recursively. A unit that performs the processing consisting of these processing steps is referred to as analysis unit.

Next, the processing for the analysis unit to find information about the object in the HPROF dump file by using the offset stored in the index information file from the given object identifier is described. This processing includes the steps of finding the row containing the same object identifier as the given object identifier in the index information file, finding the corresponding offset in the row, and accessing the HPROF dump file using the offset. It is common to use a binary search in the step of finding the row number of the row containing the same object identifier as the given object identifier in the index information file.

The binary search is a known technique described in Non-Patent Literature 1. A prerequisite for applying the binary search is that the values of data are arranged in ascending or descending order. In the following, the case of the ascending order is described as an example. The logic of explanation for the descending order is the same, except that the magnitude relationship is reversed. The binary search is a method for, when a value of data is given, searching for the value of the index corresponding to the value of the data. In this configuration, the data is the object identifier, and the index corresponds to the row number of the row that contains the object identifier in the index information file.

Here, the algorithm of the binary search is explained, defining the number of pieces of data as N, the array where the pieces of data are stored as data[ ], and the given value of data as VALUE. The array has elements of data[1] to data[N] arranged in ascending order.

First, it is assumed that the search range lower limit LOW=1, the search range upper limit HIGH=N, the midpoint of the two values MID=(LOW+HIGH)/2. It is assumed that, if (LOW+HIGH)/2 is not an integer, the fractional portion is dropped to determine the value of MID. Then, it is checked whether VALUE and data[MID] are equal. If they are equal, the index to be found is MID, and thus the value of MID is returned and the processing ends. If VALUE>data[MID], the value of LOW is re-set to MID+1 and the processing is performed again from the calculation of MID=(LOW+HIGH)/2. If VALUE <data[MID], the value of HIGH is re-set to MID−1 and the processing is performed again from the calculation of MID=(LOW+HIGH)/2. This calculation is repeated while LOW<HIGH is satisfied. If LOW≧HIGH is established during the repeated calculation, it is determined that the given data VALUE does not exist in the array data[ ].

The algorithm narrows the size of the search space to half every search until the target index is found, for example, when the number of pieces of data (ie, the initial search range) is N, the size of the search space in the next iteration is N/2, and the size of the search space in the iteration after next is N/4.

Consider this point in terms of the amount of calculation. The calculation amount of the binary search is proportional to log2 (N). log2 expresses the logarithm to the base 2. Thereafter, such a calculation amount is expressed by O (log2 (N)).

In the above, it is assumed that the pieces of data are arranged in ascending order. The pieces of data arranged in descending order can be processed in the same way, except that the magnitude relationship is reversed.

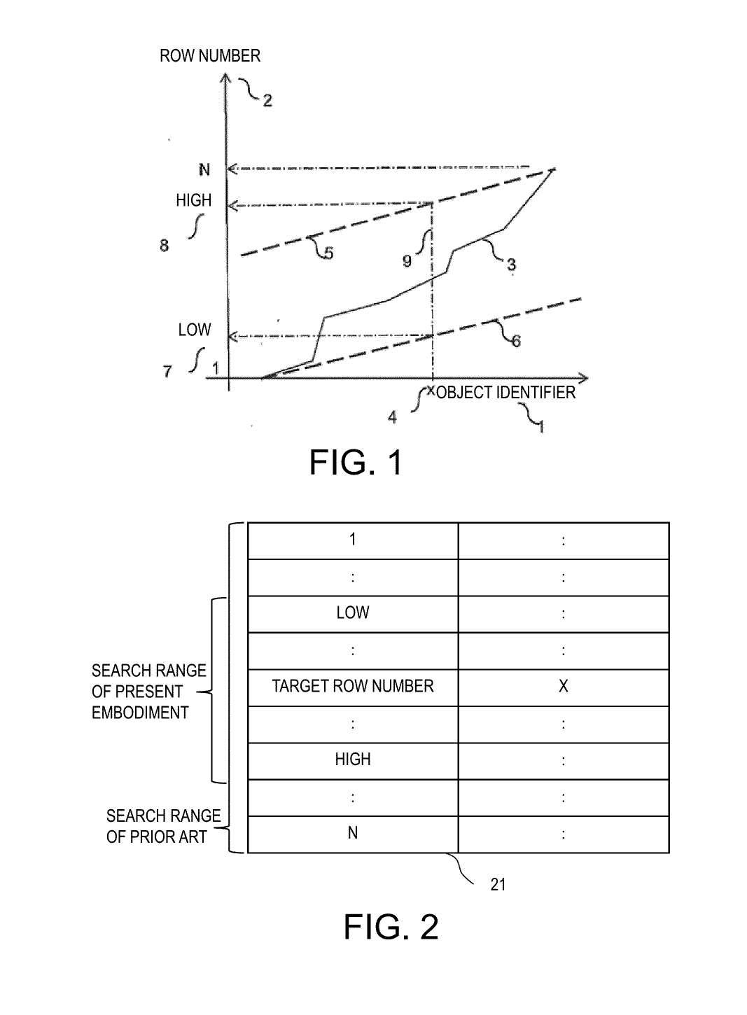

FIG. 1 depicts an example of a graph with the horizontal axis indicating the object identifier 1 and the vertical axis indicating the row number 2 where the relationship 3 between the object identifier and the row number of each object is plotted. When an object identifier x is given, the binary search is used usually for finding the row number corresponding to the object identifier x at high speed. The binary search of the prior art searches the range between the minimum value 1 and the maximum value N of the row number.

The present embodiment determines the initial values of the minimum value LOW 7 and the maximum values HIGH 8 of the row number to perform a binary search in the following manner. First, the present embodiment draws two straight lines 5 and 6 so as to sandwich the relationship 3 (hereinafter, referred to as plotted line 3) between the object identifier and the row number. Then, the present embodiment determines the row number at the point where the straight line 9 extended from the given object identifier x intersects with the straight line 5 as HIGH 8. Similarly, the present embodiment determines the row number at the point where the straight line 9 intersects with the straight line 6 as LOW 7. It is apparent that the row number to be found exists between LOW 7 and HIGH 8. Therefore, a binary search may be carried out between LOW 7 and HIGH 8. In addition, it is apparent that LOW is larger than the starting number of the row number and HIGH is smaller than N. Therefore, because the row number usually starts from 1, it is unnecessary to search the ranges from 1 to LOW−1 and from HIGH+1, resulting in a higher speed binary search than the prior art.

FIG. 2 depicts the search range illustrated in FIG. 1 in tabular form. A table 21 holds values of the object identifier in the second column and the corresponding row numbers in the first column. When an object identifier x is given, the binary search of the prior art performs a search of the row numbers in the first column from the minimum value 1 to the maximum value N. However, the binary search according to the present embodiment is required to search only the range between LOW and HIGH determined with reference to FIG. 1. Thus, the space is reduced and the binary search can be performed at higher speed than the prior art.

### Embodiment 1

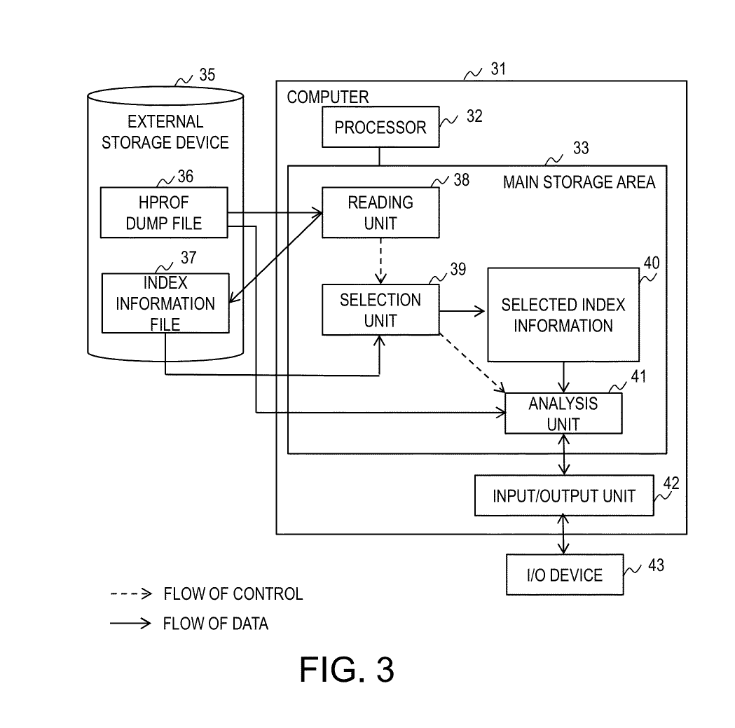

FIG. 3 depicts a configuration example of a computer system according to the present embodiment. The computer system includes a computer 31, an external storage device 35 and an I/O device 43. The computer 31 is provided with a processor 32, a main storage area 33 and an input-output unit 42. The I/O device 43 is configured to include a keyboard, a mouse and a display. A reading unit 38, a selection unit 39 and an analysis unit 41 of a dump analysis processing program are stored in the main storage area 33. In addition, a HPROF dump file 36 and an index information file 37 are stored in the external storage device 35.

Arrows written in solid lines in FIG. 3 indicate flow of data. Arrows written in dotted lines indicate flow of control, ie, the order of execution of the programs. When the dump analysis processing program is started, the reading unit 38 is executed in the first place. Reading unit 38 receives the HPROF dump file 36, and outputs the index information file 37. Then, the selection unit 39 is executed. The selection unit 39 receives the index information file 37, and outputs selected index information 40.

Finally, the analysis unit 41 is executed. The analysis unit 41 receives the HPROF dump file 36 and the selected index information 40, and outputs the analysis result. The analysis result is input to an input/output unit 42. Output of the input/output unit 42 corresponds to output of the I/O device 43. When performing the analysis interactively with a user, input from the user corresponds to output of the I/O device 43, the output of the I/O device 43 corresponds to input of the input/output unit 42, and output of the input/output unit 42 corresponds to input of the analysis unit 41.

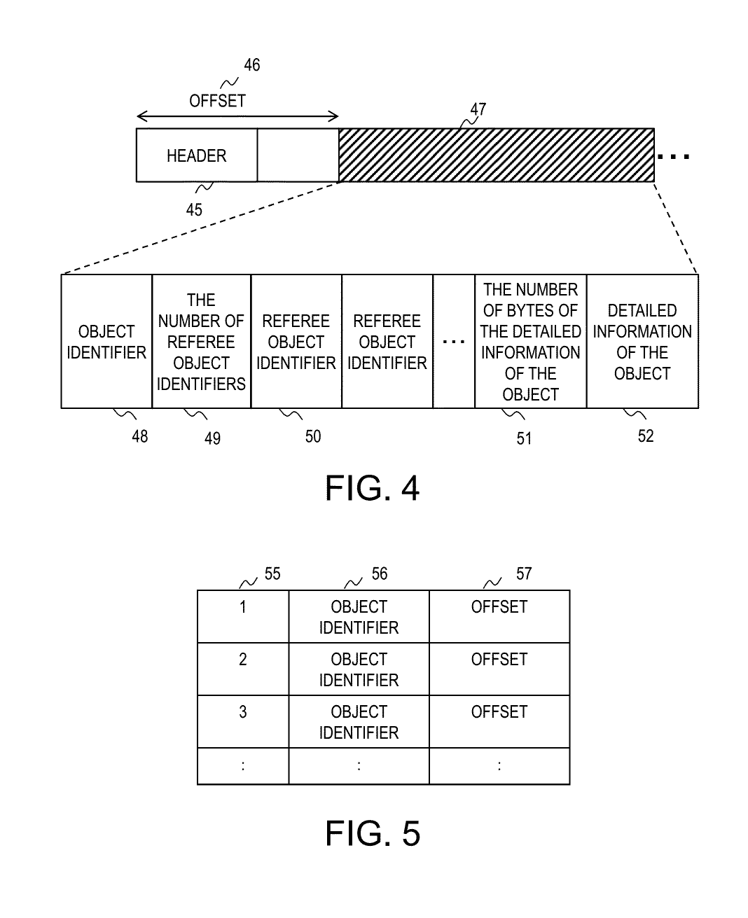

FIG. 4 depicts an example of the internal structure of the HPROF dump file 36. The HPROF dump file 36 has a header 45 at the beginning of the HPROF dump file 36. The header 45 contains the length of the header at the beginning of the header and contains information concerning Class object in the Java program in the remaining region. A Class object is an object of the java.lang.Class in the Java language, which is a special object that represents a class and an interface appearing in the Java program. Information about each object is stored behind the header 45.

A shaded region 47 in FIG. 4 is a region containing information about the second object from the beginning. The region 47 contains an object identifier 48, the number of referee object identifiers 49, 0 or more referee object identifiers 50, the number of bytes of the detailed information of the object 51, and the detailed information of the object 52. The referee object identifier 50 is the value of the object identifier of the object referenced by this object. The detailed information of the object 52 includes, for example, a memory area name, such as “eden”, “from”, “to”, “old” and “perm” of Java heap memory of a Java virtual machine where this object was stored just before the creation of the HPROF dump file 36. An offset 46 represents the distance in bytes from the beginning of the HPROF dump file 36 to the storage position of the information about the object 47.

FIG. 5 depicts an example of the internal structure of the index information file 37. Each row of the index information file 37 is configured to include row numbers 55, object identifiers 56 and offsets 57. The index information file 37 is an embodiment of the table 21 illustrated in FIG. 2. The row numbers 55 corresponds to the vertical axis of the graph illustrated in FIG. 1 and the object identifiers 56 are data corresponding to the horizontal axis of the graph illustrated in FIG. 1.

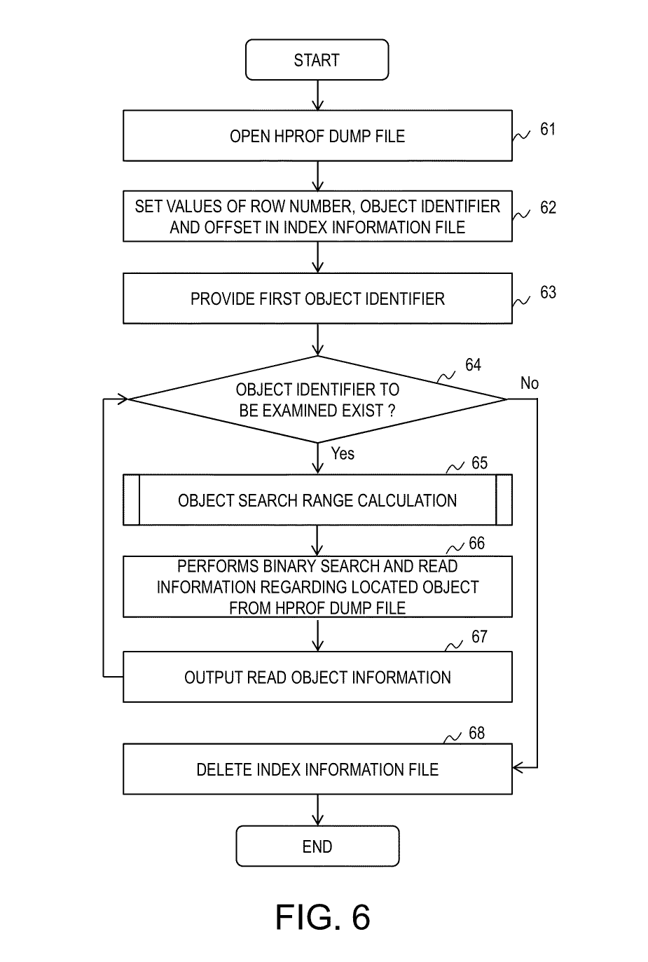

FIG. 6 depicts an example of a flowchart of the dump analysis program. Steps 61 to 63 are carried out by the reading unit 38, steps 64 to 65 are carried out by the selection section 39, and steps 66 to 68 are carried out by the analysis unit 41.

First, the step 61 opens the HPROF dump file 36. Next, the step 62 creates the index information file 37, and sets the row numbers 55, the object identifiers 56 and the offsets 57 in the index information file 37. The step 62 may set the information for each object in the index information file 37 by reading the HPROF dump file 36 from the beginning in the order. The step 63 provides the first object identifier 56. There are some methods to provide the first object identifier 56. For example, a method receives the object identifier 56 entered directly by a user from a command line, another method reads a configuration file including the pre-set object identifier 56, and another method reads the object identifier 56 of a special object called GC root object included in the header 45 of HPROF dump file 36. The first object identifier 56 may be provided by any other method.

The next step 64 checks whether the object identifier 56 to be examined exists. If the object identifier 56 is not present (branch No), the flow proceeds to the step 68 to delete the index information file, and the processing ends.

If the object identifier 56 exists (branch Yes), the object search range calculation step 65 is carried out to calculate the initial values of HIGH 8 and LOW 7 defining the search range for the object identifier 56 to be examined.

The next step 66 performs a binary search of the index information file 37 by using the calculated initial values of HIGH 8 and LOW 7, locates the row number 55 corresponding to the object identifier 56 to be examined, and determines the corresponding offset 57 from the located row number 55.

One row in the index information file 37 is comprised of three values of eight bytes (row number 55, object identifier 56, offset 57). Thus, if the row number 55 is located, the corresponding offset 46 exists at the position of (the row number−1)×16 byte from the beginning of the index information file 37. The corresponding offset 46 can be retrieved from the position.

Then, the step 66 accesses the HPROF dump file 36 by using the determined offset 46, and reads the information 47 about the object corresponding to the object identifier 56 to be examined. Then, the step 66 adds the referee object identifier 50 to the object identifier 56 to be examined next.

The next step 67 processes the information 47 about the object as necessary, outputs the result, and returns to the step 64. The loop consisting of the steps 64 to 67 is repeated until the all object identifier 56 to be examined are processed.

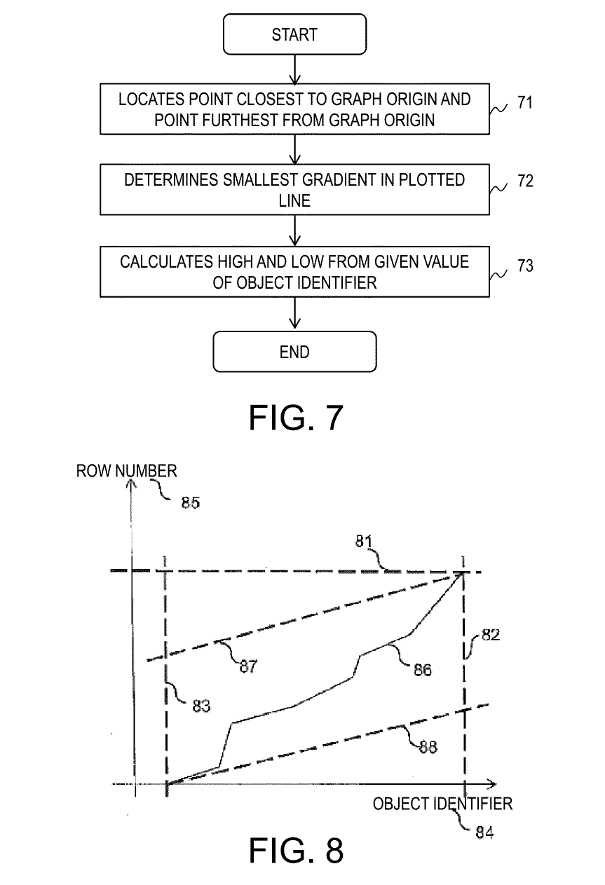

FIG. 7 depicts an example of a flowchart of the object search range calculation step 65. A step 71 locates the point closest to the graph origin and the point furthest from the graph origin. This graph is the graph illustrated in FIG. 1. The closest point is the point with the minimum object identifier 56 on the plotted line 3 and the furthest point is the point with the maximum object identifier 56 on the plotted line 3. In other words, the closest point is a set of (object identifier, row number) of the first row in the index information file 37 and the farthest point is the set of (object identifier, row number) of the last row. The former is referred as (β1, γ1) and the latter is referred as ((β2, γ2). The next step 72 determines the minimum gradient in the plotted line 3. This gradient is referred as α. The final step 73 calculates the initial values of HIGH 8 and LOW 7 from the value x of the given object identifier in accordance with the following formula:

HIGH=α×(x−β2)+γ2 formula (1)

LOW=α×(x−β1)+γ1 formula (2)

In addition, the line 5 in FIG. 1 is expressed by the formula (row number=α×(object identifier−β2)+γ2), and the line 6 is expressed by the formula (row number=α×(object identifier−β1)+γ1).

As described above, the processing illustrated in FIG. 6 and FIG. 7 allows the initial values of the binary search range upper limit HIGH 8 and lower limit LOW 7 according to the present embodiment to be calculated.

Here, the search range of the prior art binary search and the search range of the binary search according to the present embodiment are compared. As understood from FIG. 1, the search range of the prior art binary search is N−1+1=N.

In addition, γ1 is 1 and γ2 is N from their definitions. The search range of the binary search according to the present embodiment is (HIGH−LOW+1=(γ2−γ1+1)−α×(β2−β1)=N−α×(β2−β1)). Because the plotted line 3 monotonically increases, (the minimum gradient α>0) is apparent.

In addition, (β2>β1) is also apparent from the monotonic increase, resulting in (the search range of the binary search according to the present embodiment=HIGH−LOW+1=N−α×(β2−β1)<N=the search range of the prior art binary search).

Therefore, the search range of the binary search according to the present embodiment is necessarily smaller than the search range of the prior art binary search. Although the calculation amount of the prior art binary search is O (log2 (N)), the calculation amount of the binary search according to the present embodiment is O (log2 (N−α×(β2−β1))) smaller than O (log2 (N)). This proves that the binary search according to the present embodiment is faster than the prior art binary search.

FIG. 8 depicts a search range of the prior art binary search and a search range of the binary search according to the present embodiment with a plotted line 86. The search range of the prior art binary search is a rectangular area surrounded by a row number axis, a line 81 and a line 82.

On the other hand, the search range of binary search according to the present embodiment is a range surrounded by a line 87, a line 88, a line 82 and a line 83, and it is a smaller area than the rectangular area.

In other words, the processing described in the flowcharts of FIGS. 6 and 7 allows the area smaller than the rectangular area to be selected as a search area.

As described above, the search range of the binary search is reduced, and as a result, the search time can be reduced compared to the prior art binary search, thereby making it possible to shorten the time required for the analysis of the HPROF dump file.

It should be noted that the present embodiment is not limited to the binary search in the analysis processing of a HPROF dump file and is applicable to a general binary search.

The plotted line 3 is sandwiched by the two straight lines 5 and 6 of the same gradient in FIG. 1; however, the plotted line 3 may be sandwiched by two straight lines of different gradients. To that end, the step 71 in FIG. 7 locates only the point closest to the graph origin. Then, the step 72 determines the minimum gradient αmin and the maximum gradient αmax in the plotted line 3 instead of determining the minimum gradient. Then, the step 73 determines the initial values of the search range upper limit HIGH 8 and the lower limit LOW 7 by the following formulas:

HIGH=αmax×(x−β1)+γ1 formula (3)

LOW=αmin×(x−β1)+γ1 formula (4)

This method utilizes the property that plotted line 3 can be sandwiched by the straight lines of the minimum gradient (αmin) and the maximum gradient (αmax) of the straight liens passing on the point (β1, γ1) closest to the graph origin. In this case, in the range where the search range (HIGH−LOW+1)=(αmax−αmin)×(x−β1))<N is satisfied, the search range of the binary search according to the present embodiment is smaller than the search range of the prior art binary search, resulting in a faster search.

### Embodiment 2

If the plotted line 3 increases monotonically but drastically changes, the line may be divided into a plurality of areas and the straight lines to determine the search range upper and lower limits may be determined for each area.

The minute calculation of the search range allows the search range to be reduced compared to the calculation from the entire plotted line 3.

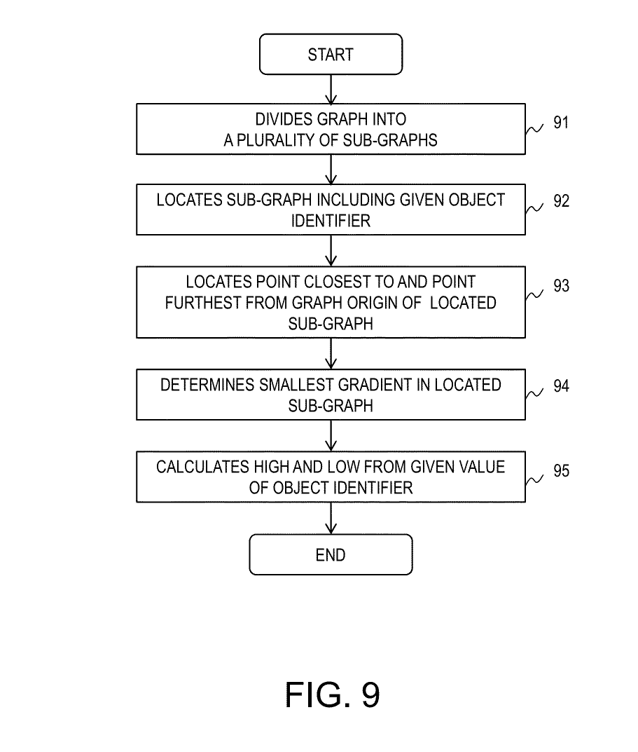

FIG. 9 depicts an example of a flowchart of the object search range calculation step 65 for dividing the plotted values (line) into a plurality of groups.

First, a step 91 divides the graph into a plurality of regions. Splitting may be performed when the distance between adjacent object identifiers 56 exceeds a predetermined threshold or when memory areas which adjacent object identifiers 56 belong to in the Java virtual machine are different, for example. A memory area which an object identifier belongs to in the Java virtual machine is a memory area for the Java virtual machine to managing the object, such as “eden”, “from”, “to”, “old” and “perm”.

The dividing processing step 91 stores the maximum object identifier and the minimum object identifier of each group in association with each group in the main storage area. The next step 92 locates the group including the given object identifier 56. The step 92 finds the group where the given object identifier 56 exists between the maximum object identifier and the minimum object identifier. The next steps 93 to 95 perform the processing performed on the entire plotted line 3 in the steps 71 to 73 on the group found in the step 92.

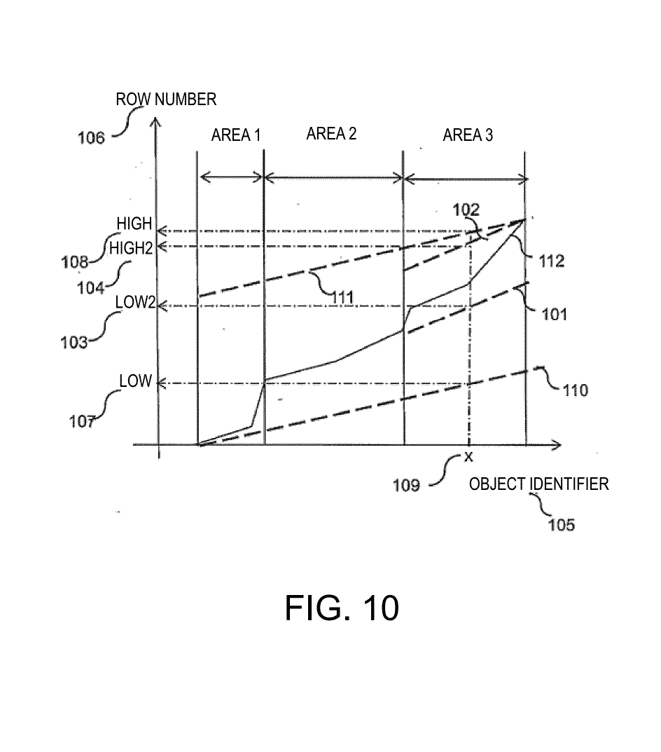

FIG. 10 depicts the difference in the initial values of the binary search range upper and lower limits between the case of dividing the plotted line graph and the case of not dividing. First, it is assumed that the line is not divided. In this case, the plotted lone 3 is sandwiched by straight lines 111 and 110, and the initial values of the binary search range upper limit and lower limit for the given object identifier x correspond to HIGH 8 and LOW 7, respectively.

On the other hand, if the plotted line 3 is divided into a plurality of groups, the given object identifier x is sandwiched between the straight lines 101 and 102 in the region 3, and the initial values of the corresponding binary search range lower and upper limits are LOW2 103 and HIGH2 104, respectively. As it is apparent from FIG. 10, the binary search range from LOW2 to HIGH2 is smaller than the binary search range from LOW to HIGH. Thus, dividing the line into a plurality of groups allows a faster search. It is possible to set two straight lines to reduce the search range in accordance with the variation of gradient of the plotted line for the region 1 and region 2 in the same manner, resulting in a more efficient search for the object.

The above described embodiments use straight lines to reduce the search area; however, a curved line such as Spline curve and Bezier curve may be used for each region.

Furthermore, it is possible to reduce the search range by asking a user to specify a passing point of a curved line or the like in order to set the curved line.

If the available space of the main storage area 33 is sufficiently large, the step 66 may, at the beginning, transfer the index information file 37 from the external storage device 35 to the main storage area 33, and perform a binary search on the main storage device 33. Thus, the faster search is achieved.

If the available space of the main storage area 33 is not sufficiently large, the step 66 may, at the beginning, transfer only the information between the initial values of the binary search range lower and upper limits from the external storage device 35 to the main storage area 33, and perform a binary search on the main storage area 33. Thus, the faster search is achieved

It should be noted that the scope of the present invention is not limited to the HPROF dump file 36, which is a dump file of the Java heap memory, and the present invention is applicable to a common memory dump file outputting objects in ascending or descending order of the addresses. Moreover, the method for calculating the binary search range lower and upper limits according to the present invention is applicable to any type of data to which the prior art binary search is applicable, as well as the memory dump file.

The above has described embodiments for implementing the present invention, the invention is not limited to the above described configurations, and it is possible to take various configurations without departing from the spirit thereof.

Further, software and the like for realizing the functional units mentioned above may be recorded on magnetic or optical portable recording medium and be installed to a computer by using them.

Furthermore, it is also possible to install the software to the computer by downloading it via a network such as the Internet.

### REFERENCE SIGNS

1 Object Identifier
2 Row Number
3 Plotted line (The Relationship between The Object Identifier and Row Number)
4 Given Object Identifier
7 Binary Search Range Lower Limit
8 Binary Search Range Upper Limit
31 Computer
32 Processor
33 Main Storage Area
35 External Storage Device
36 HPROF Dump File
37 Index Information File
65 Object Search Range Calculation Processing

1. An analysis method of dump information comprising:
collecting, by a reading unit, index information from dump information stored in a first storage area and storing the index information in the first storage area, the index information consisting of object identifiers arranged in ascending or descending order and row numbers each being information regarding an offset in a file of corresponding object identifier of the object identifiers;
selecting, by a selection unit, information of an region on a graph with a first axis indicating the object identifiers and a second axis indicating row numbers as index information that can be referenced, the area being smaller than a rectangle defined by an origin point and a position of a maximum object identifier on the graph when points of the object identifiers are plotted on the graph; and
performing, by an analysis unit, a binary search on the object identifiers by using the selected index information.

2. The analysis method according to claim 1, wherein the area selected by the selection unit is an area between two straight lines sandwiching all the points of the object identifiers plotted on the graph.

3. The analysis method according to claim 2, wherein the two straight lines consists of a line passing on a point closest to the graph origin with a minimum gradient among gradients defined between adjacent points on the graph and a line passing on a point furthest from the graph origin with the minimum gradient.

4. The analysis method according to claim 1 further comprising:
dividing, by the selection unit, the points of the object identifiers into a plurality of groups; and
determining, by the selection unit, a pair of two lines to be used for each of the plurality of groups.

5. The analysis method according to claim 1 further comprising copying the selected index information to a second storage area with access speed faster than the first storage area,
wherein the binary search is performed, by the analysis unit, on the object identifiers by using the index information in the second storage area.

6. The analysis method according to claim 5 further comprising, when the index information that can be referenced exceeds capacity of the designated second storage area, dividing the index information that can be referenced so that size of a divided piece of the index information falls within the capacity.

7. An analysis apparatus of dump information comprising:
a reading unit configured to collect index information from dump information stored in a first storage area and store the index information in the first storage area, the index information consisting of object identifiers arranged in ascending or descending order and row numbers each being information regarding an offset in a file of corresponding object identifier of the object identifiers;
a selection unit configured to select information of an region on a graph with a first axis indicating the object identifiers and a second axis indicating row numbers as index information that can be referenced, the area being smaller than a rectangle defined by an origin point and a position of a maximum object identifier on the graph when points of the object identifiers are plotted on the graph; and
an analysis unit configured to perform a binary search on the object identifiers by using the selected index information.

8. The analysis apparatus according to claim 7, wherein the area selected by the selection unit is an area between two straight lines sandwiching all the points of the object identifiers plotted on the graph.

9. The analysis apparatus according to claim 8, wherein the two straight lines consists of a line passing on a point closest to the graph origin with a minimum gradient among gradients defined between adjacent points on the graph and a line passing on a point furthest from the graph origin with the minimum gradient.

10. The analysis apparatus according to claim 7, wherein the selection unit is configured to divide the points of the object identifiers into a plurality of groups, and determine a pair of two lines to be used for each of the plurality of groups.

11. The analysis apparatus according to claim 7,
wherein analysis apparatus is configure to copy the selected index information to a second storage area with access speed faster than the first storage area, and
wherein the analysis unit is configured to perform the binary search on the object identifiers by using the index information in the second storage area.

12. The analysis apparatus according to claim 11, wherein, the analysis apparatus is configured to divide the index information that can be referenced so that size of a divided piece of the index information falls within capacity of the designated second storage area on condition that the index information that can be referenced exceeds the capacity.

13. A non-transitory computer readable storage medium for storing instructions, which, when executed on a computer, cause a processor to perform processing for analyzing dump information, wherein the processing comprising:
collecting, by a reading unit, index information from dump information stored in a first storage area and storing the index information in the first storage area, the index information consisting of object identifiers arranged in ascending or descending order and row numbers each being information regarding an offset in a file of corresponding object identifier of the object identifiers;
selecting, by a selection unit, information of an region on a graph with a first axis indicating the object identifiers and a second axis indicating row numbers as index information that can be referenced, the area being smaller than a rectangle defined by an origin point and a position of a maximum object identifier on the graph when points of the object identifiers are plotted on the graph; and
performing, by a analysis unit, a binary search on the object identifiers by using the selected index information.

14. The non-transitory computer readable storage medium according to claim 13, wherein the area selected by the selection unit is an area between two straight lines sandwiching all the points of the object identifiers plotted on the graph.
